(19) United States
(12) Patent Application Publication
(10) Pub. No.: US 2023/0215227 A1
(43) Pub. Date: Jul. 6, 2023

(54) SYSTEM AND METHOD FOR VEHICLE DATA MANAGEMENT

(71) Applicants: Sam Hijazi, Austin, TX (US); Christopher Reynoso, Austin, TX (US); Ahmad El Solh, Austin, TX (US)

(72) Inventors: Sam Hijazi, Austin, TX (US); Christopher Reynoso, Austin, TX (US); Ahmad El Solh, Austin, TX (US)

(21) Appl. No.: 17/569,644

(22) Filed: Jan. 6, 2022

(51) Int. Cl. G07C 5/08; G07C 5/00; G06F 40/40; G06N 20/00

(52) U.S. Cl. CPC G07C 5/0816; G07C 5/008; G07C 5/0808; G06F 40/40; G06N 20/00

(57) ABSTRACT

Systems and methods for vehicle information analysis and management via a network are disclosed, including a mobile device operable to capture an image of a vehicle information sticker using an image capturing component and communicatively coupled to the network, a server operable to receive the captured image of the vehicle information sticker via the network and perform an image processing operation on the image, and a vehicle information repository database that is operable to store vehicle information associated with the vehicle information sticker in non-transitory memory after the image processing operation has been performed.

### TECHNICAL FIELD

The embodiments disclosed herein generally relate to computer implemented systems and methods for vehicle information analysis and management via a network.

### BACKGROUND

Automobile and other vehicle sales often occur at centralized locations called dealerships. Dealerships or car dealers, as they are known in the automobile industry, are merchants who specialize in the buying, selling, trading, and leasing of various types of vehicles. The stock or collection of vehicles sold at any particular dealership may be specific to a particular manufacturer with whom the proprietor of the dealership has a special contractual relationship (e.g. Dodge, Jeep, Oldsmobile, Toyota, Fiat, Chrysler, Mercedes, or many others). As such, all new automobiles sold at any particular physical dealership location may be of a particular manufacturer brand, in addition to any service and/or purchasing operations. However, consumers may not be completely loyal to any given brand when it comes time to purchase or lease a new vehicle, or sell and old vehicle. As such, the vehicle they are selling may not match the brand of the vehicle they are buying (e.g. a Toyota truck owner may wish to purchase a Dodge sports car, and go to a Dodge dealership where he wishes to trade or sell his Toyota truck). Dealers are well accustomed to this type of dealing and will therefore often sell used cars that may not be the same brand as the new car brand they are affiliated with. This can cause issues when a dealer does not have perfect or great information about the particular models that other car manufacturers are selling. Furthermore, any given vehicle model may have many different options packages that were offered when the vehicle was originally sold (e.g. sport package, speed package, off road package, and many others) and often consumers will special order customized options for their new vehicles from the manufacturer. As such, there are a large number of combinations of features and options that any given vehicle might have compared to others in its class across all years and manufacturers. This can create a problem for dealers who wish to maximize their profit on any given sale and minimize their exposure to purchasing unpopular models and/or options packages.

Historically there have been different attempts at addressing the problem of efficiently and accurately identifying the particular features and options that any particular vehicle may have. Vehicle Identification Numbers (VINs) are unique alphanumeric combinations that were created and implemented on each vehicle in order to correctly identify information about a specific vehicle. While VINs have certainly helped alleviate the identification issues for vehicles, dealers may still not have total accuracy in their identifying features and options for vehicles they purchase from consumers or take in trade that were manufactured by a different manufacturer.

Another useful tool has been the mandating and inclusion of Monroney stickers on automobiles. Monroney stickers generally include a variety of information about the car including the manufacturer's suggested retail price (MSRP), engine and transmission specifications, standard equipment and warranty details, optional equipment and pricing, city and highway fuel economy ratings, crash test ratings, and others, as time passes and further inclusions are mandated. As such, Monroney stickers can be a good location to find out about many different features, characteristics, and options about any given vehicle on a dealer's lot. Unfortunately, not all dealerships keep meticulous records that are readily searchable but which would be highly advantageous to both the dealership staff and the consuming public. As such, the use of computer implemented systems and methods can greatly enhance vehicle information analysis and management in this context.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to vehicle inventory management and analysis. In general, these computer implemented systems and methods include the use of image capturing of vehicle information, performing one or a series of operations on the captured information and building and enhancing an inventory management system.

Systems and methods implemented according to the teachings described herein can be used to determine what options for a specific vehicle exist when the text relating to a vehicle's features has been captured and processed. Each manufacturer is known to use unique codes for vehicle features and options packages, even across different models under their own brands. An example of a downstream capability of these systems and methods includes using the information to tell the difference between a premium package and a “p1” package, which may mean similar things in terms of the respective options and features associated therewith, but have different names for different automobile manufacturers.

Furthermore, in various embodiments data that has been created and/or modified by the systems and methods herein can also be sent to or accessed and used by third parties.

Thus, the systems and methods herein can be used to digitize vehicle window sticker information, sending the information to webpages, and also sending the information to third parties, such as vendors.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates an example embodiment of a window sticker capture operation using a mobile device; and

FIGS. 3A-3B illustrate a flowchart of a vehicle document information gathering process, according to some embodiments.

### DETAILED DESCRIPTION

Before describing example embodiments in detail, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

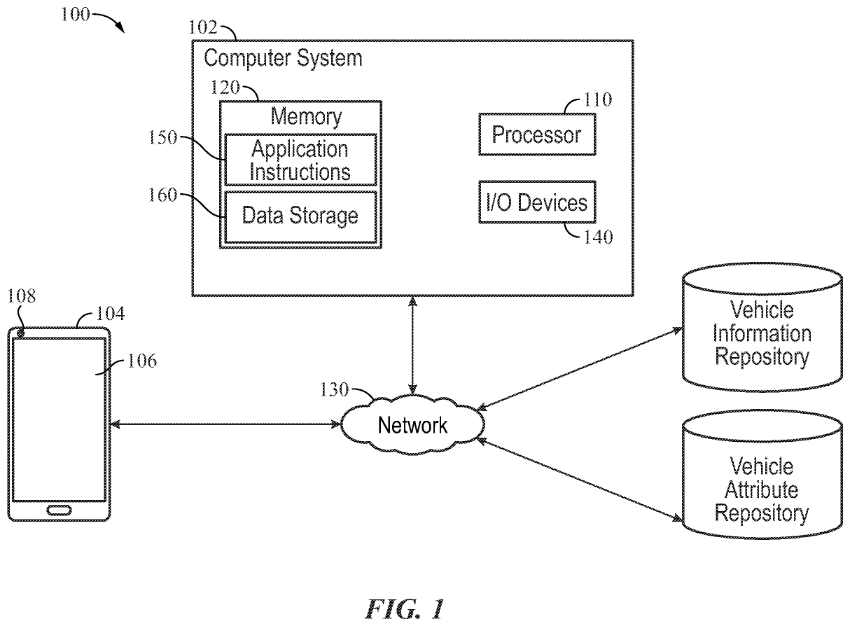

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVAS-CRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more battery if computer system 102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102 coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g. a digital camera, scanner, or others) and associated structures and elements operatively coupled to at least one processor and memory of the mobile computing device. Such image capturing component 108 can be operable to capture an image of a label and/or code (e.g. a quick response (QR) code or others) automatically or upon one or more user input commands.

In yet other embodiments, mobile computing device 104 can be replaced or supplemented with a scanner, printer, or computer system or device having scanning functionality. As those in the art will understand, processes described with respect to mobile computing device 104 may thus be supplemented or replaced completely by such scanner. In such cases, labels and/or other paperwork, contracts, financial documents, leases, or the like may be scanned using the scanner. The scanned document(s) can be saved in non-transitory computer readable memory on the scanning device or removable hardware (e.g. thumbdrive, CD-ROM, DVD, Blu-Ray disc, removable hard drive, or otherwise) and fed directly to computer system 102, and/or the information from the scanned document(s) can be transmitted via the network using appropriate networking equipment, components, and/or functionality. Those in the industry will recognize that many, if not most, dealerships currently have scanners that can perform such functionality.

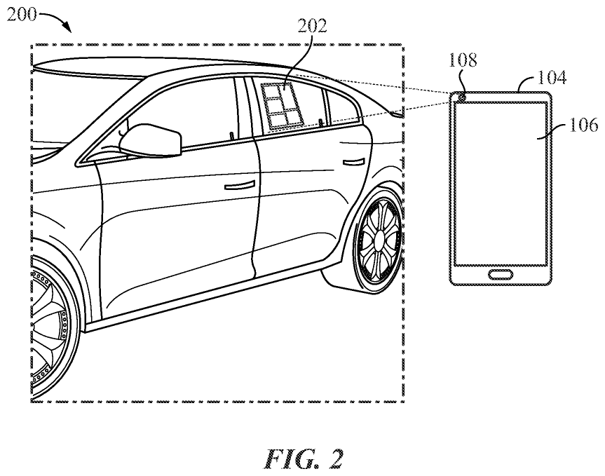

FIG. 2 illustrates an example embodiment use case 200 of a window sticker 202 capture operation using a mobile device 104. As shown in the example embodiment, a user can take a mobile device 104 and aim an image capturing component 108 toward a window sticker 202 of a vehicle, for example at a car dealership, auction, or elsewhere. Alternatively, as described in the previous paragraph, window stickers and/or a wide variety of other documents can be physically taken by an employee or automated device to a scanner and scanned. Thereafter, the document can be stored in non-transitory computer readable memory in an individual digital file and/or database and recalled, accessed, used, parsed, or otherwise function to provide information for use in the embodiments described herein.

While physical paperwork is depicted in the example embodiment shown in FIG. 2, those in the art will recognize that in some embodiments, digital information may be stored in memory and accessed via a network and/or physically for use in the system. This information may come from a centralized or distributed server, from local or remote computers, from a manufacturer, from a dealer or dealer group, from third-party data storage, or otherwise.

In still other embodiments, physical documents may be scanned and stored remotely and accessed or received at a local dealership computer via a network or physical data storage medium for use.

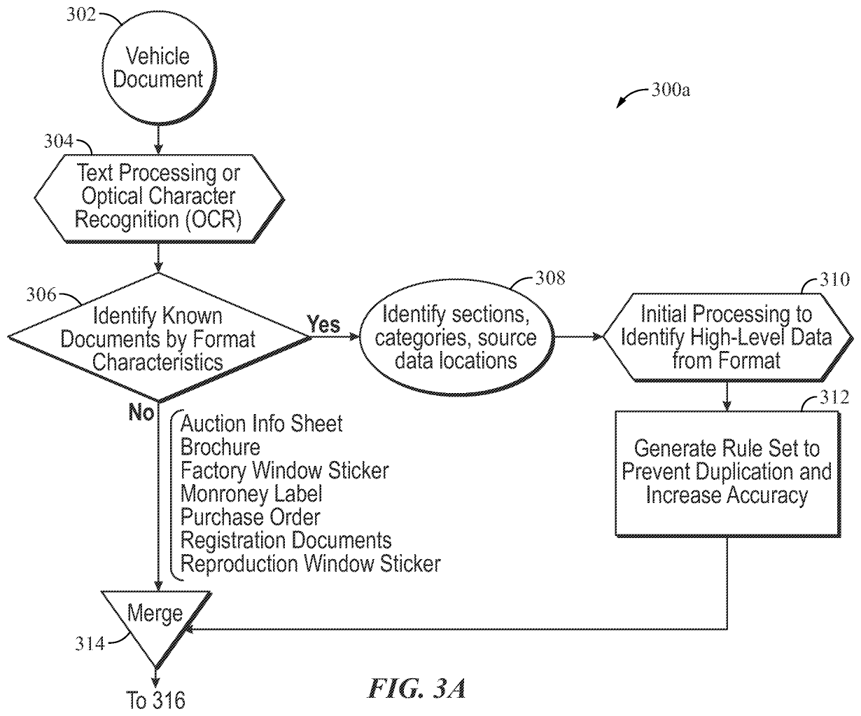

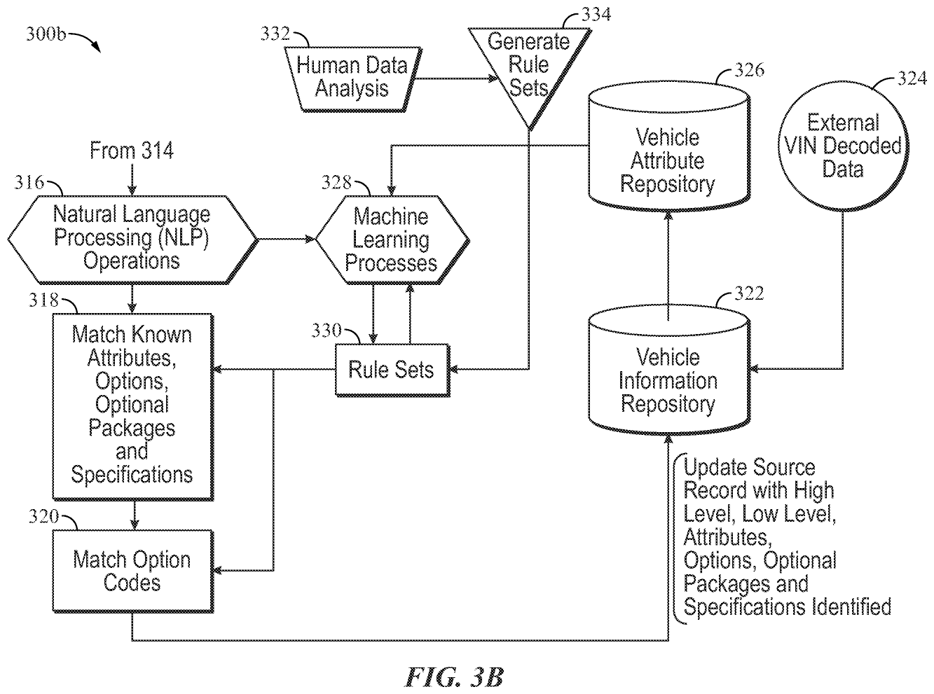

FIGS. 3A-3B illustrate a flowchart 300a, 300b of a vehicle document information gathering process, according to some embodiments. As shown in the example embodiment, an image of one or more vehicle documents 302 (e.g. window sticker 202 of FIG. 2, also known as a Monroney label, or other document with information about the vehicle) can be captured using a camera, scanner, or otherwise (e.g. using image capturing component 108 of FIG. 2). This image can be locally run through at least one text processing or optical character recognition (OCR) operation on the mobile device or transferred via the network and run through the same operations on a server or computing device (e.g. computer system 102 of FIG. 1) in step 304. Once this operation has been performed and the image has been broken down into data, the document may be identified using known characteristics in step 306. These characteristics can indicate that the document is an auction info sheet, a brochure, a factory window sticker, a Monroney label/sticker, a purchase order, a registration documents, a reproduction window sticker, or others. If the document is identified as one having known format characteristics, the next step 308 can be for the system to identify sections, categories, source data locations, and/or other information before proceeding to step 310 in which initial processing can be performed on the data in order to identify high-level data from the format. Next, at least one rule set can be generated in step 312 in order to prevent duplication of information and to increase accuracy of information about the vehicle before proceeding to a merge step 314. Likewise, if no known characteristics are identified in step 306, the system can proceed to a merge step 314. Merge step 314 is operable to supplement, augment, or otherwise improve system robustness by combining known document format characteristics with any modifications, updates, or changes that may exist between different vehicle documents 302 in memory and improve usability of the system for future operations. The flowchart 300a process from FIG. 3A is continued after step 314 with natural language processing (NLP) operations in step 316 of flowchart 300b of FIG. 3B.

NLP operations step 316 can be used to parse data and identify useful and important pieces of information before performing step 318 in which known attributes, options, optional packages and specifications can be matched with or pulled from the data. Thereafter, option codes for particular manufacturers and models can be matched with data about the specific vehicle in step 320. Matched option codes can subsequently be stored in non-transitory memory in vehicle information repository 322, which can be one or more databases coupled with or on, or otherwise accessible from a system server. At this point, source records can be updated with high level and/or low level attributes, options, optional packages, and specifications can be identified. Vehicle information respository 322 can also receive external vehicle identification number (VIN) decoded data 324. This information can be pulled or accessed from one or more databases or other systems, or otherwise inputted or pushed to vehicle information repository 322. In general, vehicle information repository 322 is generally only accessible by subscribers and/or users from a single dealer or dealer group account with access to the system or which the system is implemented in coordination with. As such, one dealer or dealer group may not be able to access or use data from other dealers, unless they are linked or otherwise affiliated in the system in a particular fashion. In some embodiments providing a more robust database that is publicly accessible by many or all dealers can be beneficial, while in other embodiments privacy may be desirable in order to maintain a competitive edge.

Data from vehicle information repository 322 can also be stored in one or more vehicle attribute repository database(s) 326, which can be accessed by or data can be sent to and used in machine learning processes 328. Machine learning processes 328 can also receive inputs from NLP operations 316 and may work with, exchange data with, and/or train rule sets 330. In various embodiments, one or more components of the vehicle information repository environment 300 combine to supply an ingestion pipeline. The ingestion pipeline is the mechanism via which information is processed for stored storage. In certain embodiments the pipeline performs operations including parsing and scanning, machine learning operations, and translation operations. In various embodiments, the parsing operations will produce a plurality of parse trees. The machine learning operations resolve which know edge elements within the parse tree provide a best result representing a meaning of the text, the machine learning operation identifying knowledge elements of the plurality of parse trees representing ambiguous portions of the vehicle data, and the conceptualization operations identify relationships between target attributes and data identified from the elements of the parse trees produced from the parsing operation. In certain embodiments, the machine learning operations provide a resolution for the plurality of parse trees to a best tree representing an interpretation of the ambiguous portions of the text. Rule sets generated from these embodiments in totality will cover historical data and training. If possible, attribute data could be “Sunroof” for example, then expansions into a tree may contain outputs including or similar to “Panoramic Sunroof”, “Sunroof/Moonroof”, “Targa Top”, “Pano Roof”.

Human data analysis can occur in step 332, the results of which can be used as input or to otherwise generate rule sets in step 334. These rule sets can be used in step 330, which can send data to step 318 and/or step 320. Input from the vehicle document cannot be trusted to be completely equivalent to the source document as OCR processes are known to frequently contain errors. These patterns may not readily be acceptable for attribute matching nor machine learning by itself, as they may introduce errors that could cost money or time to remedy, at best. There are situations where inputs from source documents may originally be significantly different from the input (e.g. “Quick Order Package 441B” vs “Quick Order Package AA1B”). For the highest level of accuracy human intervention may be required here in some instances to complete prescriptive analytics and to provide additional rule sets to gracefully match these situations where machine learning generated rule sets do not adequately cover inaccurately scanned text matching to otherwise semantically different attributes.

At different times and in many instances of system implementations a vehicle may be sold or otherwise transferred out of a particular dealer's inventory. In such instances the data regarding the sold or transferred vehicle can be retained by the system (e.g. in vehicle information repository 322 and vehicle attribute repository 326 of FIG. 3B) and used to train and/or retrain the algorithms. In many instances, vehicle information can be retained indefinitely unless culling operations are performed on system data or the information is manually or automatically deleted for some particular reason.

Much of the information retained in system databases is not necessarily unique to each vehicle, since there are a finite number of combinations of packages and equipment for any given make and model. In general, the processes herein are operable to take basic vehicle information with a finite list of available packages and identify the exact set of equipment equipped on the vehicle when it was originally sold. Of course any information about a specific vehicle can be saved with a coordinating cross-reference with a VIN number for specific vehicle packages.

A variety of machine learning processes can be employed in the systems and methods herein. These can include supervised learning (e.g. for classification and others), which can be used to create one or more ruleset(s), to processes vehicle information (e.g. trim, color scheme(s), drivetrain, engine attributes, options, optional packages, specifications, styles, supported fuel types, transmission, and others). In various embodiments, each iteration may generate additional rules for identifying potential matches based on the associated label.

Users can generally provide a base set of rules for operations where machine learning currently is not as accurate or robust as desirable. As an example, user interaction can help provide error correction rules for imperfect data that is not perfectly identifiable by or exists outside of the machine learning based OCR engine.

In various embodiments the systems described herein may not have a unique user interface of their own, but may be implement within or coupled to other systems (e.g. existing dealer inventory management systems). Data can be visualized in these inventory management systems and/or on or through the dealer's website (e.g. a user may see the optional package, e.g. “Premium P1 Package,” selected or listed) in a manner consistent with the existing style and feel of the existing inventory management system.

The main system users in many embodiments are dealers and their employees and agents, as primary system subscribers. However, data that has been run through the system can also be visible to their end consumers on dealer websites and may also be sent downstream to syndicated listing sites (e.g. Autotrader, Cargurus, and others) or marketing operations.

While no subscriber tier model is currently used, different models can be implemented within and work in harmony with the system. However, the system is operable to take the material that is inputted and perform various operations on it in order to identify any pertinent data that may be used to enhance and/or correct previously stored data for any specific VIN and associated vehicle.

In some embodiments radio-frequency identification (RFID) or other near field tags can be used in addition to or as a substitute for visual labels that may contain information about a vehicle. As such, additional functionality associated therewith is contemplated and can be implemented without departing from the scope of the embodiments described previously. For example, an RFID tag could be located in or on some location of a vehicle and an RFID reader can read the information stored thereon and associated with the vehicle. This information may then be parsed and used as described in the embodiments herein. Those in the art will understand that such tags and such readers may involve in sophistication over time but generally will be operable in known fashions, whereby one or more signals are sent or received when the components are located within a physical range or proximity that can then be downloaded to or uploaded from the reader to a device (if the reader is not itself implemented on a device with communicative functionality and capabilities) that is coupled with the system or with a network that is also coupled with the system.

Future developments of information associated with vehicle packages and options are also contemplated. For example, electric vehicles have specific electrical tolerances, charge storage amounts, battery types, configurations and other information pertinent to electrical vehicles that may not be pertinent to hybrid or internal combustion engine vehicles. Likewise, hydrogen fuel cell or other vehicles may have certain storage capabilities, outputs, and the like that are currently or may become useful for dealers to track, as per government mandate, consumer interest, or other dealer incentive.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for vehicle information analysis and management via a network, comprising:
a mobile device operable to capture an image of a vehicle information sticker using an image capturing component and communicatively coupled to the network;
a server operable to receive the captured image of the vehicle information sticker via the network and perform an image processing operation on the image; and
a vehicle information repository database that is operable to store vehicle information associated with the vehicle information sticker in non-transitory memory after the image processing operation has been performed.

2. The system of claim 1, wherein the image processing operation comprises an image text processing operation.

3. The system of claim 1, wherein the image processing operation comprises an optical character recognition (OCR) operation.

4. The system of claim 1, wherein the image processing operation comprises a document format identification operation.

5. The system of claim 4, wherein if the document format identification operation identifies known format characteristics, the server performs initial processing to identify high-level data from the format.

6. The system of claim 1, wherein the server is further operable to perform at least one natural language processing operation.

7. The system of claim 6, wherein the natural language processing operation is used in at least one machine learning process.

8. The system of claim 7, wherein the at least one machine learning processes is operable to exchange data with at least one rule set in non-transitory computer readable memory.

9. The system of claim 8, wherein the at least one rule set is used to match at least one option code.

10. The system of claim 9, wherein the matched at least one option code is stored in the vehicle information repository database.

11. A computer implemented method for vehicle information analysis and management via a network, comprising computer instructions stored in non-transitory computer readable memory of a server that, when executed by a processor of the server cause the server to perform the steps of:
performing an image processing operation on an image captured by a mobile device communicatively coupled with the server after receiving the captured image is received via the network; and
storing vehicle information associated with the captured image in non-transitory memory in a vehicle information repository database after the image processing operation has been performed,
wherein the captured image comprises an image of a vehicle information sticker.

12. The computer implemented method of claim 11, wherein the image processing operation comprises an image text processing operation.

13. The computer implemented method of claim 11, wherein the image processing operation comprises an optical character recognition (OCR) operation.

14. The computer implemented method of claim 11, wherein the image processing operation comprises a document format identification operation.

15. The computer implemented method of claim 14, wherein if the document format identification operation identifies known format characteristics, the server performs initial processing to identify high-level data from the format.

16. The computer implemented method of claim 11, wherein the server is further operable to perform at least one natural language processing operation.

17. The computer implemented method of claim 16, wherein the natural language processing operation is used in at least one machine learning process.

18. The computer implemented method of claim 17, wherein the at least one machine learning processes is operable to exchange data with at least one rule set in non-transitory computer readable memory.

19. The computer implemented method of claim 18, wherein the at least one rule set is used to match at least one option code.

20. The computer implemented method of claim 19, wherein the matched at least one option code is stored in the vehicle information repository database.
